(19) United States
(12) Patent Application Publication
(10) Pub. No.: US 2003/0104241 A1
(43) Pub. Date: Jun. 5, 2003

(54) Metal-polyurethane laminates

(76) Inventor: Werner Rasshofer, Koln (DE)

Correspondence Address: BAYER POLYMERS LLC, 100 BAYER ROAD, PITTSBURGH, PA, 15205, US

(21) Appl. No.: 10/302,569

(22) Filed: Nov. 22, 2002

(30) Foreign Application Priority Data
Nov. 28, 2001 (DE) 10158491.1

(51) Int. Cl. B32B 15/08

(52) U.S. Cl. 428/626; 156/331.7

(57) ABSTRACT

The present invention relates to laminates comprising metal and compact or cellular polyurethane resins, to processes for the production of these laminates, and to the production of molded articles comprising these laminates.

### BACKGROUND OF THE INVENTION

This invention provides laminates consisting of metal and compact or cellular polyurethane resins and processes for the production thereof.

Laminates consisting of steel and polypropylene are already used in the construction of automobiles, for example, for dashboard supports, roofing panels, panelling, parts of housings, hoods, etc. Here, owing to the thermoplastic interlining material, the heat resistance is in many cases still inadequate; moreover, considerable expense is required in order to achieve a sufficiently strong polypropylene-steel bond.

WO 98/21029 discloses laminated sandwich components for ship building, in which two steel plates are bonded together by a core of polyurethane elastomer. The steel plates have a thickness of 6 to 25 mm; the polyurethane elastomer has a tensile strength of 20 to 55 MPa, a bending modulus of 2 to 104 MPa, an elongation of 100-800% and a hardness of Shore 70A to Shore 80D.

WO 99/64233 discloses laminated panels having the following layer structure: metal (2-20 mm)/compact polyisocyanate polyaddition product (10-100 mm)/metal (2-20 mm). The polyisocyanate polyaddition product has a modulus of elasticity of >275 MPa within the temperature range of −45° C. to +50° C., an adhesion to the metal of >4 MPa, an elongation of >30% within the temperature range of −45° C. to +50° C., a tensile strength of >20 MPa and a compressive strength of >20 MPa.

U.S. Pat. No. 6,050,208 discloses laminated panels for ship building, in which the elastomer layer has a modulus of elasticity of ≦250 MPa.

These laminates are unsuitable for building non-marine vehicles. In particular, they cannot be processed by deep-drawing and adhesion between the metal and the elastomer still is insufficient.

### SUMMARY OF THE INVENTION

The invention relates to laminated panels which have at least one composite layer comprising the following sequence of layers:

B1) a layer of metal, 0.05 to 1.0 mm thick,

A) a layer of polyurethane resin, 0.05 to 10 mm thick, and

B2) a layer of metal, 0.05 to 1.0 mm thick.

These laminated panels are moldable, i.e. capable of being deep-drawn.

The present invention also relates to processes for the production of these laminated panels, wherein A) a layer of polyurethane resin having a thickness of from 0.05 to 10 mm, is located between two layers B1) and B2) of metal, with each layer of metal having a thickness of from 0.05 to 1.0 mm. Either process of producing these laminated panels results in the same sequence of materials as described above.

One process comprises:

(1) applying a reaction mixture between two layer of metal B1) and B2), wherein each layer of metal has the desired thickness, and

(2) curing the reaction mixture to form a layer of polyurethane resin, thus forming the laminate.

The layer of polyurethane resin in the resultant laminate preferably has a thickness of from 0.05 10 mm as described above.

An alternate process comprises:

(1) applying a reaction mixture to a first layer of metal B1) which is characterized by a thickness of from 0.05 to 1.0 mm,

(2) placing a second layer of metal B2) over the reaction mixture, wherein the layer of metal B2) has a thickness of from 0.05 to 1.0 mm, and

(3) curing the reaction mixture, thus forming the laminate.

In this embodiment, the layer of polyurethane resin in the resultant laminate also preferably has a thickness of from 0.05 to 10 mm as described above.

Preferred reaction mixtures of forming the polyurethane resin comprise:

a) a polyisocyanate component,

b) a polyol component,

and, optionally, one or more of:

c) components selected from the group consisting of cross-linking agents, chain extenders and mixtures thereof,

d) catalysts,

e) blowing agents

f) compounds selected from the group consisting of fillers and reinforcing materials, and

g) auxiliary substances and additives.

The present invention also relates to a process for the production of a molded article which is suitable for automotive and/or aircraft construction. This process is a vacuum-forming process wherein the layers of metal are positioned over the inside portions of the mold and vacuum-formed in position inside the mold, the lined mold is filled with a polyurethane resin forming reaction mixture, followed by curing, and removing the molded article from the mold.

### DETAILED DESCRIPTION OF THE INVENTION

The outer layers B1) and B2) of the laminated panels preferably comprise the same metal material and are preferably of the same thickness. If outer layers B1) and b2) comprise the same metallic material, their surfaces may optionally be modified differently. The suitable metals which may be used as B1) and/or B2) may be any metallic material conventionally employed in the construction of airborne, waterborne or earthbound vehicles such as, for example, for car body sheets. In particular, metals such as steel, aluminium, magnesium and the common alloys and modifications of these metals, including all types of surface modifications (surface coatings) known to the person skilled in the art. Such surface coatings are produced, for example, by anodizing, phosphatizing, chromizing, galvanizing, and are known to the person skilled in the art. The preferred metal is car-body steel. Both unmodified and surface-modified car-body steel can be used. Surface modification can be achieved by treatment with inorganic agents, for example, by anodizing, phosphatizing, chromizing, galvanizing, or organic agents, like epoxide resins or polyurethane resins.

The inner layer A) of the laminates comprises a compact and/or cellular polyurethane resin. The polyurethane resins suitable for the present invention are those which are produced by the reaction of a) a polyisocyanate component, b) a polyol component, and optionally, c) one or more cross-linking agents and/or chain extenders, optionally, d) one or more catalysts, optionally, e) a blowing agent, preferably water as blowing agent, optionally, f) one or more fillers and reinforcing materials, and optionally g) other auxiliary substances and additives. It is preferred that the polyurethane resin layer of the present laminated panels has a thickness of from 0.05 to 10 mm.

Compounds suitable for use as the starting component a) for the present invention include aliphatic, cycloaliphatic, araliphatic, aromatic and heterocyclic polyisocyanates as described, for example, by W. Siefken in Justus Liebigs Annalen der Chemie, 562, pages 75 to 136, for example, those corresponding to the formula:

Q(NCO)n,

wherein:

n equals a number of from 2 to 4, preferably 2, and

Q represents an aliphatic hydrocarbon group having 2-18 carbon atoms, preferably having 6-10 carbon atoms, a cycloaliphatic hydrocarbon group having 4-15 carbon atoms, preferably having 5-10 C atoms, an aromatic hydrocarbon group having 6-15 carbon atoms, preferably having 6-13 carbon atoms, or an araliphatic hydrocarbon group having 8-15 carbon atoms, preferably having 8-13 carbon atoms.

Preferably the technically readily accessible polyisocyanates are used such as, for example, tolylene 2,4- and 2,6-diisocyanate and any mixtures of these isomers (TDI), polyphenyl polymethylene polyisocyanates, which are prepared by aniline-formaldehyde condensation and subsequent phosgenation (“crude MDI”), higher aromatic isocyanates of the diphenylmethane diisocyanate series (PMDI types) and polyisocyanates containing carbodiimide groups, urethane groups, allophanate groups, isocyanurate groups, urea groups or biuret groups (“modified polyisocyanates”), and, in particular, those modified polyisocyanates which are derived from tolylene 2,4- and 2,6-diisocyanate or from diphenylmethane 4,4′- and/or 2,4′-diisocyanate. Naphthylene 1,5-diisocyanate or mixtures of the above-mentioned polyisocyanates are also suitable. Crude MDI is particularly preferred used for this invention.

Polyols containing at least two H (i.e. hydrogen) atoms which are reactive to isocyanate groups are suitable as polyol component b) in the present invention. It is preferred that polyester polyols and polyether polyols are used, with polyether polyols being particularly preferred. Such polyether polyols can be prepared by known processes such as, for example, by anionic polymerization of alkylene oxides in the presence of alkali hydroxides or alkali alcoholates as catalysts and with the addition of at least one starter molecule which contains bonded reactive hydrogen atoms, or by cationic polymerization of alkylene oxides in the presence of Lewis acids such as antimony pentachloride or boron trifluoride etherate. Suitable alkylene oxides contain, for example, from 2 to 4 carbon atoms in the alkylene group. Some examples are tetrahydrofuran, 1,3-propylene oxide, 1,2- or 2,3-butylene oxide; preferably ethylene oxide and/or 1,2-propylene oxide are used. The alkylene oxides may be used separately, alternately in succession with each other, or as mixtures. Preferred mixtures are those consisting of 1,2-propylene oxide and ethylene oxide, in which the ethylene oxide is used in quantities of 10 to 50% as ethylene oxide end block (i.e. “EO cap”), so that the resulting polyols have more than 70% primary OH end groups. Suitable examples of starter molecules include water or polyhydric alcohols, such as ethylene glycol, 1,2-propanediol and 1,3-propanediol, diethylene glycol, dipropylene glycol, 1,4-butanediol, glycerol, trimethylolpropane, pentaerythritol, sorbitol, saccharose, etc. The suitable polyether polyols, preferably polyoxypropylene-polyoxyethylene polyols, have a functionality of 2 to 8 and number-average molecular weights of 800 to 18,000 g/mol, preferably 1,000 to 4,000 g/mol.

Suitable polyester polyols can be prepared, for example, from organic dicarboxylic acids having 2 to 12 carbon atoms, preferably aliphatic dicarboxylic acids having 4 to 6 carbon atoms, and polyhydric alcohols, preferably diols, having 2 to 12 carbon atoms, preferably 2 carbon atoms. Examples of suitable dicarboxylic acids are: succinic acid, glutaric acid, adipic acid, suberic acid, azelaic acid, sebacic acid, decanedicarboxylic acid, maleic acid, fumaric acid, phthalic acid, isophthalic acid and terephthalic acid. Here, the dicarboxylic acids may be used separately or as mixtures with one another. Instead of the free dicarboxylic acids, the corresponding dicarboxylic acid derivatives may be used, such as, for example, dicarboxylic acid mono- and/or diesters of alcohols having 1 to 4 carbon atoms, or dicarboxylic anhydrides. Preferably, dicarboxylic acid mixtures of succinic acid, glutaric acid and adipic acid in proportions of, for example, 20 to 35/35 to 50/20 to 32 parts by weight are used, and in particular adipic acid. Examples of dihydric and polyhydric alcohols are ethanediol, diethylene glycol, 1,2- and 1,3-propanediol, dipropylene glycol, 1,4-butanediol, 1,5-pentanediol, 1,6-hexanediol, neopentyl glycol, 1,10-decanediol, glycerol, trimethylolpropane and pentaerythritol. Compounds preferably used as dihydric and polyhydric alcohols are 1,2-ethanediol, diethylene glycol, 1,4-butanediol, 1,6-hexanediol, glycerol, trimethylolpropane or mixtures of at least two of the above-mentioned diols, in particular, mixtures of ethanediol, 1,5-butanediol and 1,6-hexanediol, glycerol and/or trimethylolpropane are preferred. Polyester polyols obtained from lactones, for example, ε-caprolactone, or from hydroxycarboxylic acids, for example, ω-hydroxycaproic acid and hydroxyacetic acid, may also be used.

To prepare the polyester polyols, the organic polycarboxylic acids and/or their derivatives are polycondensed together with polyhydric alcohols, advantageously in the molar ratio of 1:1 to 1:1.8, preferably of 1:1.05 to 1:1.2. The polyester polyols obtained have a functionality preferably of 2 to 3, more preferably of 2 to 2.6, and a number-average molecular weight of 400 to 6,000, preferably 800 to 3,500.

Suitable polyester polyols which may also be mentioned include polycarbonates containing hydroxyl groups. Suitable polycarbonates containing hydroxyl groups are those of the type known per se, which can be prepared, for example, by the reaction of diols, such as 1,2-propanediol, 1,4-butanediol, 1,6-hexanediol, diethylene glycol, trioxyethylene glycol and/or tetraoxyethylene glycol, with diaryl carbonates, for example, diphenyl carbonate or phosgene.

In order to produce the PU elastomers according to the invention, in addition to the polyol component, i.e. component b) as described above, one or more low-molecular weight difunctional chain extenders, one or more low-molecular weight (preferably tri- or tetrafunctional) cross-linking agents, or mixtures of chain extenders and of cross-linking agents may be used as component c). Such chain extenders and cross-linking agents, component c), are included in the reaction mixture in order to modify the mechanical properties, particularly the hardness, of the PU elastomers. Suitable chain extenders, such as, for example, alkanediols, dialkylene glycols and polyalkylene polyols, and cross-linking agents such as, for example, tri- or tetrahydric alcohols and oligomeric polyalkylene polyols having a functionality of 3 to 4, which may be, for example, adducts of ethylene oxide and/or propylene oxide to trimethylolpropane or glycerol having high OH values, usually possess molecular weights of <800, preferably of 18 to 400 and more preferably of 60 to 300. Compounds preferably used as chain extenders are alkanediols having 2 to 12 carbon atoms, and preferably 2, 4 or 6 carbon atoms such as, for example, ethanediol, 1,3-propanediol, 1,5-pentanediol, 1,6-hexanediol, 1,7-heptanediol, 1,8-octanediol, 1,9-nonanediol, 1,10-decanediol, and in particular, 1,4-butanediol, and dialkylene glycols having 4 to 8 carbon atoms, for example, diethylene glycol and dipropylene glycol as well as polyoxyalkylene glycols. Branched-chain and/or unsaturated alkanediols having usually not more than 12 carbon atoms are also suitable compounds for component c). Some such compounds include, for example, 1,2-propanediol, 2,2-dimethyl-1,3-propanediol, 2-butyl-2-ethyl-1,3-propanediol, 2-butene-1,4-diol and 2-butyne-1,4-diol, diesters of terephthalic acid and glycols having 2 to 4 carbon atoms, such as, for example, bis(ethylene glycol) terephthalate or bis(1,4-butanediol) terephthalate, hydroxyalkylene ethers of hydroquinone or of resorcinol such as, for example, 1,4-di(β-hydroxyethyl)hydroquinone or 1,3-(β-hydroxyethyl)-resorcinol, alkanolamines having 2 to 12 carbon atoms, such as ethanolamine, 2-aminopropanolamine and 3-amino-2,2-dimethylpropanol, N-alkyldialkanolamines, for example, N-methyl- and N-ethyldiethanolamine, (cyclo)aliphatic diamines having 2 to 15 carbon atoms, such as 1,2-ethylenediamine, 1,3-propylenediamine, 1,4-butylenediamine and 1,6-hexamethylenediamine, isophorone diamine, 1,4-cyclohexamethylene-diamine and 4,4′-diaminodicyclohexylmethane, N-alkyl-, N,N′-dialkyl-substituted- and aromatic diamines, which may also be substituted on the aromatic ring by alkyl groups, having 1 to 20 carbon atoms, preferably 1 to 4 carbon atoms in the N-alkyl group, such as N,N′-diethyl-, N,N′-di-sec-pentyl-, N,N′-di-sec.-hexyl-, N,N′-di-sec.-decyl- and N,N′-dicyclohexyl, p- or m-phenylenediamine, N,N′-dimethyl-, N,N′-diethyl-, N,N′-diisopropyl-, N,N′-di-sec.-butyl-, N,N′-dicyclohexyl-4,4′-diamino-diphenylmethane, N,N′-di-sec.-butylbenzidine, methylenebis(4-amino-3-benzoic acid, methyl ester), 2,4-chloro-4,4′-diaminodiphenylmethane, 2,4- and 2,6-tolylenediamine.

Any of the compounds constituting component c) may be used in the form of mixtures or individually. Mixtures of one or more chain extenders and one or more cross-linking agents may also be used.

To adjust the hardness of the PU elastomers, the constituent components b) and c) can be varied in relatively wide proportions. In general, the hardness and rigidity of the PU elastomers increases as the content of component c) increases in the reaction mixture.

Depending on the desired properties, such as, for example, adhesion, deep-drawing quality, heat resistance, etc., the required quantities of the constituent components b) and c) can be readily determined by experiment. It is advantageous to use 1 to 100 parts by weight, preferably 3 to 50 parts by weight, of the chain-extending and/or cross-linking agent c), based on 100 parts by weight of the higher molecular compounds b).

Components b) and c) are also preferably so chosen such that together they have an OH value of 100 to 500 mg KOH/g and a functionality of 2 to 8.

Catalysts which are known in the field of polyurethane chemistry may be used as component d). Some examples of suitable catalysts include catalysts such as, for example, tertiary amines, such as triethylamine, tributylamine, N-methylmorpholine, N-ethylmorpholine, N,N,N′N′-tetramethylethylenediamine, pentamethyidiethylenetriamine and higher homologues (as described in, for example, DE-OS 26 24 527 and 26 24 528), 1,4-diazabicyclo[2.2.2]octane, N-methyl-N′-dimethyl-aminoethyl-piperazine, bis(dimethylaminoalkyl)piperazines (as described in, for example, DE-OS 26 36 787), N,N-dimethylbenzylamine, N,N-dimethyl-cyclohexylamine, N,N-diethylbenzylamine, bis(N,N-diethylaminoethyl) adipate, N,N,N′,N′-tetramethyl-1,3-butanediamine, N,N-dimethyl-1-phenylethylamine, bis(dimethylaminopropyl)urea, 1,2-dimethylimidazole, 2,-methylimidazole, monocyclic and bicyclic amidines (as described in, for example, DE-OS 17 20 633), bis(dialkylamino)alkyl ethers (as described in, for example, U.S. Pat. No. 3,330,782, the disclosure of which is herein incorporated by reference, DE-AS 10 30 558, DE-OS 18 04 361 and 26 18 280) as well as tertiary amines containing amide groups (preferably formamide groups) as described in, for example, DE-OS 25 23 633 and 27 32 292. Known per se Mannich bases obtained from secondary amines, such as dimethylamine, and from aldehydes, preferably formaldehyde, or from ketones, such as acetone, methyl ethyl ketone or cyclohexanone and from phenols, such as phenol, nonylphenol or bisphenol, are also suitable as catalysts for the present invention. Suitable tertiary amine catalysts which contain hydrogen atoms that are active to isocyanate groups include, for example, triethanolamine, triisopropanolamine, N-methyldiethanolamine, N-ethyldiethanolamine, N,N-dimethylethanolamine, their reaction products with alkylene oxides such as propylene oxide and/or ethylene oxide, as well as secondary-tertiary amines as described in DE-OS 27 32 292. Silaamines containing carbon-silicon bonds, which are described in U.S. Pat. No. 3,620,984, the disclosure of which is herein incorporated by reference, can also be used as catalysts. These compounds include, for example, 2,2,4-trimethyl-2-silamorpholine and 1,3-diethylaminomethyltetramethyldisiloxane. Also suitable are nitrogen-containing bases such as tetraalkylammonium hydroxides, as well as alkali hydroxides such as sodium hydroxide, alkali phenolates such as sodium phenolate, or alkali alcoholates such as sodium methylate. Hexahydrotriazines can also be used as catalysts (see DE-OS 17 69 043). The reaction between NCO groups and Zerewitinoff-active hydrogen atoms is also greatly accelerated by lactams and azalactams, an associate between the lactam and the compound containing acid hydrogen initially being formed. Such associates and their catalytic action are described in, for example, DE-OS 20 62 286, 20 62 289, 21 17 576, 21 29 198, 23 30 175 and 23 30 211. According to the invention, organometallic compounds can also be used as catalysts. Organotin compounds are preferred catalysts for the invention. Besides sulfur-containing compounds such as di-n-octyltin mercaptide (as described in U.S. Pat. No. 3,645,927, the disclosure of which is herein incorporated by reference), suitable organotin compounds include preferably tin(II) salts of carboxylic acids, such as tin(II) acetate, tin(II) octoate, tin(II) ethylhexoate and tin(II) laurate, and tin(IV) compounds such as, for example, dibutyltin oxide, dibutyltin dichloride, dibutyltin diacetate, dibutyltin dilaurate, dibutyltin maleate or dioctyltin diacetate.

All the above-mentioned catalysts may, of course, be used as mixtures. Of particular interest in the present invention are combinations of organometallic compounds and amidines, aminopyridines or hydrazinopyridines (as described in, for example, DE-OS 24 34 185, 26 01 082 and 26 03 834).

Further examples of suitable catalysts to be used in accordance with the present invention and details of the mode of action of the catalysts are described in: R. Vieweg, A. Höchtlen (Ed.) “Kunststoff-Handbuch”, Volume VII, Carl Hanser Verlag, Munich 1966, pp. 96-102.

The catalysts or combinations of catalysts are generally used in a quantity of between about 0.001 and 10 wt. %, preferably 0.01 to 1 wt. %, based on the total quantity of compounds containing at least two hydrogen atoms which are reactive to isocyanates.

According to the invention, compact polyurethane resins can be produced in the absence of moisture and of physically or chemically acting blowing agents. In order to produce cellular, preferably microcellular, polyurethane resins, the blowing agent e) used is preferably water. The blowing agent, which reacts in situ with the organic polyisocyanates a) or with prepolymers containing isocyanate groups, with the formation of carbon dioxide and amino groups, which for their part continue to react with further isocyanate groups to form urea groups and, thus, act as chain extenders. If water is additionally introduced into the polyurethane formulation in order to produce a polyurethane resin having a required density, this is generally used in quantities of 0.01 to 2.0 wt. %, preferably of 0.2 to 1.2 wt. %, based on the combined weight of the constituent components b) and c). Carbon dioxide salts of amines, such as carbonates or carbamates (salts of carbamic acid), which produce a uniform frothy foam, can likewise be used. Examples of suitable amines are aminoethanol and short-chain polyether polyamines.

Fillers and reinforcing materials f) may also optionally be added to the reaction mixture for producing the polyurethane resins. Examples of suitable fillers and reinforcing materials are siliceous minerals such as, for example, sheet silicates such as antigorite, serpentine, hornblende, amphibole, chrisotile, talc; metal oxides, such as kaolin, aluminium oxides, titanium oxides, titanates and iron oxides; metal salts such as chalk, heavy spar and inorganic pigments, such as cadmium sulfide, zinc sulfide, as well as glass, asbestos powder, etc. Preferably, natural and synthetic fibrous minerals such as asbestos, wollastonite, are used, and in particular glass fibers of various lengths, which optionally may be sized. Fillers may be used separately or as mixtures. The fillers, if present at all, are added to the reaction mixture advantageously in quantities of up to 50 wt. %, preferably of up to 30 wt. %, based on the combined weight of components b) and c).

Additives g) may also optionally be incorporated into the reaction mixture for producing the polyurethane resins. Some examples of such additives which may be mentioned are surface-active additives, such as emulsifiers, foam stabilizers, cell regulators, flameproofing agents, nucleating agents, oxidation inhibitors and heat stabilizers, stabilizers, lubricants and mold-release agents, dyes, dispersing agents and pigments. Suitable emulsifiers are, for example, the sodium salts of sulfated castor oil or salts of fatty acids with amines, such as oleic acid diethylamine or stearic acid diethanolamine. Alkali metal salts or ammonium salts of sulfonic acids such as, for instance, dodecylbenzenesulfonic acid or dinaphthylmethane-disulfonic acid or of fatty acids, such as ricinoleic acid, or of polymeric fatty acids may also be used concomitantly as surface-active additives. Polyether siloxanes, especially the water-soluble representatives, are most suitable as foam stabilizers. These compounds are generally so constituted that a copolymer of ethylene oxide and propylene oxide is bonded to a polydimethylsiloxane group. Such foam stabilizers are described, for example, in U.S. Pat. Nos. 2,834,748, 2,917,480 and 3,629,308, the disclosures of which are herein incorporated by reference. Of particular interest are polysiloxane-polyoxyalkylene copolymers multiply branched via allophanate groups as described in DE-OS 25 58 523. Other organopolysiloxanes, oxyethylated alkylphenols, oxyethylated fatty alcohols, paraffin oils, ricinoleic esters, Turkey-red oil and peanut oil and cell regulators such as paraffins, fatty alcohols and dimethylpolysiloxanes are also suitable. Moreover, oligomeric polyacrylates having polyoxyalkylene groups and fluoroalkane groups as side groups are suitable for improving and/or stabilizing the emulsifying action, the dispersion of the filler and the cell structure. The surface-active substances are conventionally used in quantities of 0.01 to 5 parts by weight, based on 100 parts by weight of polyol b). One may also add reaction inhibitors such as, for example, acid-reacting substances such as hydrochloric acid, or organic acids and acid halides, also known per se cell regulators such as paraffins or fatty alcohols or dimethylpolysiloxanes, as well as pigments or dyes or known per se flameproofing agents, for example, tris(chloroethyl) phosphate, tricresol phosphate or ammonium phosphate and ammonium polyphosphate, also stabilizers against the effects of ageing and weathering, plasticizers and fungistatic and bacteriostatic substances. Examples of suitable antioxidizing heat stabilizers are the compounds of the diphenylamine, BHT, HALS, benzotriazole, et cetera type, known to the person skilled in the art. Such compounds are available from, for example, the firms of Ciba and Goldschmidt.

Further examples of surface-active additives and foam stabilizers which optionally may be used according to the invention, and of cell regulators, reaction inhibitors, stabilizers, flame retardants, plasticizers, dyes and fillers as well as fungistatic and bacteriostatic substances, together with details concerning the method of application and mode of action of these additives are described in R. Vieweg, A. Höchtlen (Ed.) “Kunststoff-Handbuch”, Volume VII, Carl Hanser Verlag, Munich 1966, pp. 103-113.

The polyurethane resins according to the invention can be produced by various procedures. Thus, for example, mixtures of polyol b), and ptionally chain extenders and/or cross-linking agents c), optionally catalysts d), optionally e) water, optionally f) fillers and reinforcing materials, and/or optionally g) auxiliary substances and additives are reacted with organic polyisocyanates a). In another embodiment of the process, prepolymers containing isocyanate groups which are prepared by reacting a polyisocyanate component a), with a polyol component b), are reacted with chain extenders and/or cross-linking agents c), or with mixtures of given proportions of a polyol component b) and chain extenders and/or cross-linking agents c), or mixtures of given proportions of a polyol component b), chain extenders and/or cross-linking agents c) water, or preferably with mixtures of chain extenders and/or cross-linking agents c) and water.

The polyurethane resins according to the invention can be produced by the processes described in the literature, for example, by the one-shot process or the prepolymer process, with the aid of mixing devices which are known in principle to the person skilled in the art. They are produced preferably by the one-shot process.

The components are reacted in quantities such that the equivalent ratio of the NCO groups of the polyisocyanates a) to the sum of the hydrogen atoms of components b) and c) which are reactive with isocyanate groups and optionally e) water is from 0.5:1 to 2:1, preferably from 0.8:1 to 1.2:1 and in particular from 0.8:1 to 0.9:1.

If they are produced without fillers and reinforcing materials, the polyurethane resins according to the invention have an average density of 0.3 to 1.1 g/cm³. Higher densities such as, for example, 1.1 to 1.3 g/cm³, can be attained by using fillers and reinforcing materials in the polyurethane forming reaction mixture. The resultant polyurethane resins have a modulus of elasticity of <250 MPa (20° C.). They have a heat resistance of >200° C.; i.e. on being tempered for 30 minutes at 200° C., they show a loss of mass of <1 wt. %. Densities of lower than 0.3 g/cm³ can be attained, but they have been found unsuitable for the intended application.

The laminated panels according to the invention can be produced by placing the polyurethane reaction mixture between two layers of metal, B1) and B2), wherein each of the metal layers is from 0.05 to 1.0 mm in thickness, and curing them there. To this end, for example, the top layers B1) and B2) can be positioned at the required distance apart in a mold or by means of spacers and the gap filled with the reaction mixture. In a continuous variation of the process, the reaction mixture is continuously applied between two continuously guided metal sheets. The resulting laminated panel is then passed through rolls, and in this way, is adjusted to the required thickness. Alternatively, the reaction mixture may first of all be applied to metal layer B1), and then covered with layer B2). In all the methods of production, the reaction mixture is cured after being placed or applied between the two metal layers B1) and B2), and thus, bonds to the metal layers. The thickness of the layer of polyurethane resin in the laminated panels varies from 0.05 to 10 mm.

To improve the adhesion between polyurethane resin and the metal layers, the contact surface of the metal layers may be pretreated with an adhesive primer. Suitable polyurethane- and epoxide-based primers are in principle known. Inorganic primers such as, for example, sodium orthosilicate (waterglass), or mixtures of an inorganic primer and an organic polymer, for example, in the form of an aqueous dispersion, are also suitable.

The laminates according to the invention are preferably used in automobile construction and aircraft construction, for example, for producing car-body parts, paneling, parts of housings, hoods, roofing panels etc.

The laminates according to the invention afford significant advantages compared with structural parts manufactured entirely from metal or with the steel-plastics laminates of prior art. Thus, they have the advantage of lower weight (in particular where cellular polyurethane resins are used) accompanied by an equal or greater rigidity. Reduction in weight is associated with lower fuel consumption, and hence, with an increased saving of resources. They exhibit a distinctly better temperature resistance than do the steel-plastics laminates of prior art. As the polyurethane resins used have a modulus of elasticity of <250 MPa, the laminates according to the invention are advantageously processed by deep drawing, which is necessary for three-dimensional articles such as automobile parts (hoods, etc.). Moreover, the laminates according to the invention exhibit better sound-absorbing properties than do pure metal parts or steel-plastics laminates containing plastics which have a higher modulus of elasticity. Compared with the steel laminates for ship building previously described in the literature, the laminates according to the invention have an increased deep-drawing quality, i.e. no cohesive rupture and no detachment from the wall on bending at 180°.

The invention is further illustrated but is not intended to be limited by the following examples in which all parts and percentages are by weight unless otherwise specified.

### EXAMPLES

### Example 1

### Production of a Laminate

In order to produce a laminate, the following polyurethane reaction system was used:

Polyol formulation (component A):

70.30 parts by wt. of a polyether polyol started on glycerol, having a number-average molar mass of 6011 g/mol, which contains 82.3 wt. % PO and 17.7 wt. % of a terminal EO block,

20.00 parts by wt. of a polyoxypropylene polyol started on trimethylolpropane, having a number-average molar mass of 306 g/mol,

7.00 parts by wt. 1,4-butanediol,

2.00 parts by wt. of a polymeric catalyst capable of incorporation (Bayfill® additive VP.PU 591F08, Bayer AG)

The polyol formulation had an OH value of 221.

Isocyanate component (component B):

Crude MDI containing 1 to 5 wt. % 2,4′-MDI, 44 to 55 wt. % 4,4′-MDI and 40 to 55% polymethylene poly(phenyl isocyanate).

The foaming ratio of component A: component B was 100:52 parts, which corresponds to a reference number (i.e. Isocyanate Index) of 100.

The PU material was mixed by means of a static mixer type BD 1 (0.6×32). The device had a nozzle diameter of 6 mm; the processed material was sheared 32 times prior to being discharged at the nozzle. At a discharge capacity of approximately 600 g/min, the injection time inclusive of introduction and discharge was restricted to 10 seconds.

By means of laboratory tests, the following reaction times were established for the processing described above: filament drawing time 3 minutes, tack-free time 3.5 minutes.

In order to produce test laminates (steel sheet/PU/steel sheet) in accordance with the present inventon, electrogalvanically zinc-coated steel sheets, each sheet having a thickness of 0.25 mm and dimensions of about 20 cm×30 cm were used. The two metal sheets were painted on one side with a conventional, commercially available, one-component primer (VP 13808, IGP GmbH, D-48249, Dülmen). The metal sheets were placed in a drying oven at 70° C. for approximately 15 minutes in order to ventilate and bake the primer. The PU reaction mixture was cooled to room temperature and then applied to the primed side of one of the metal sheets and, after the application, was immediately covered with the second metal sheet. The layer thickness of the PU material was adjusted to 1 mm and the laminate was stored for approximately 15 minutes at room temperature and then for approximately 30 minutes at about 70° C.

The peel resistance of the resulting laminate, measured in accordance with DIN EN 1464, was 45.6 N/cm. The workability by forming was examined by means of a bending test. To this end, the laminate was bent by 90° and then bent back again. No detachment of the resin from the metal was observed.

To establish the mechanical and thermomechanical data for the PU material used, test plates were produced in the laboratory. To this end, components A and B were weighed out in the ratio of 100:52 in a suitable vessel and mixed together for 15 seconds by means of a Pendraulik mixer at a stirring speed of 4200 rev/min. Then, 350 g of the mixture was placed in a flat mold (having dimensions of 200 mm×200 mm×10 mm) which was pre-heated to 70° C., the mold was closed and vented. Approximately 5 minutes after the mixture had been placed in the mold, it was possible to release the finished plate, the bulk density of which was approximately 875 kg/m³. After the plates had been stored for 24 hours at room temperature, the following mechanical and thermal properties were ascertained:

| | | |
|---|---|---|
| DIN 527-1 | Tear resistance at 20° C. [N/mm²] | 7.87 |
| DIN 527-1 | Elongation at tear at 20° C. [%] | 41.38 |
| DIN 527-1 | Tensile modulus at 20° C. [N/mm²] | 119 |
| DIN 53423 | Bending modulus at 20° C. [N/mm²] | 61 |
| DIN 53423 | Bending modulus at 80° C. [N/mm²] | 7 |
| DIN 53505 | Hardness [Shore D] | 52 |

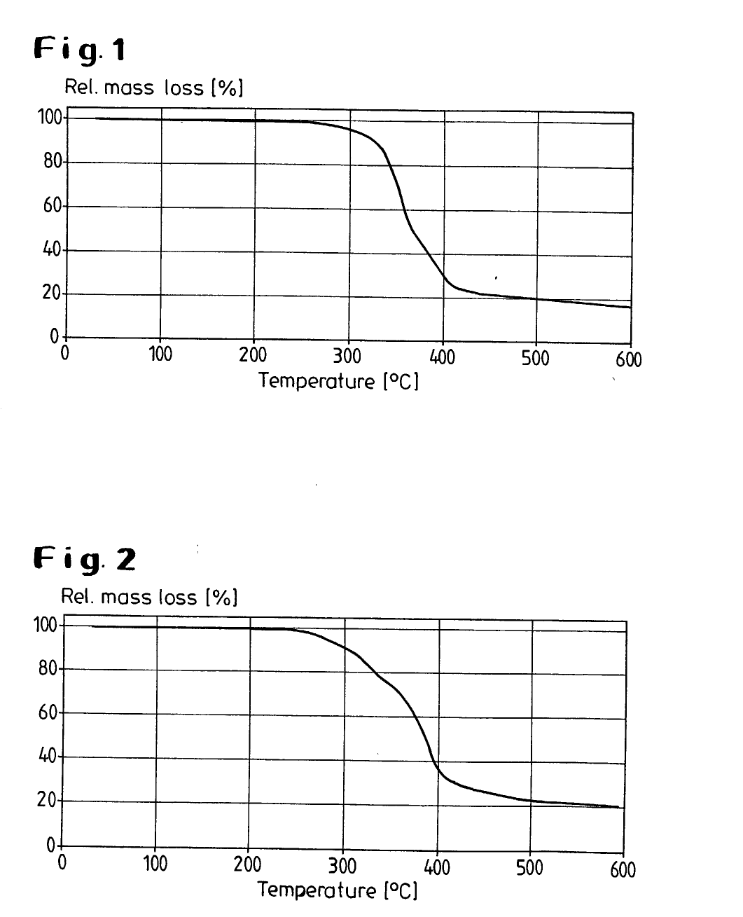

The decomposition temperature of the PU material was determined thermogravimetrically by means of TGA (Thermo Gravimetric Analysis). At a heating rate of 20 K/min, the onset of decomposition was observed at 347° C. and, at a heating rate of 5 K/min, at 326° C. FIG. 1 shows the graph obtained by TGA of the sample in nitrogen atmosphere at a heating rate of 5 K/min.

### Example 2

### Production of a Laminate

In order to produce a laminate, the following polyurethane reaction system was used:

Polyol formulation (component A):

| | |
|---|---|
| 69.30 parts by wt. | of a polyether polyol started on glycerol, having a |
| | number-average molar mass of 6011 g/mol, |
| | which contains 82.3 wt. % PO and 17.7 wt. % of a |
| | terminal EO block, |
| 11.80 parts by wt. | of a polyoxypropylene polyol started on |
| | trimethylolpropane, having a number-average |
| | molar mass of 306 g/mol, |
| 10.00 parts by wt. | ethylene glycol, |
| 7.80 parts by wt. | polyethylene glycol having a number-average |
| | molar mass of 600 g/mol, |
| 0.05 parts by wt. | dibutyltindilaurate, |
| 16.70 parts by wt. | of a wollastonite-type filler, |

The polyol formulation had an OH value of 241.

Isocyanate component (component B):

Crude MDI containing 1 to 5 wt. % 2,4′-MDI, 44 to 55 wt. % 4,4′-MDI and 40 to 55% polymethylene poly(phenyl isocyanate).

The foaming ratio of component A: component B was 100:57 parts, which corresponds to a reference number (i.e. Isocyanate Index) of 100.

The PU material was mixed by means of a static mixer type BD 1 (0.6×32). The device had a nozzle diameter of 6 mm; the processed material was sheared 32 times prior to being discharged at the nozzle. At a discharge capacity of approximately 600 g/min, the injection time inclusive of introduction and discharge was restricted to 10 seconds.

By means of laboratory tests, the following reaction times were established for the processing described above: filament drawing time 3 minutes, tack-free time 3.5 minutes.

In order to produce test laminates (steel sheet/PU/steel sheet) in accordance with the present inventon, electrogalvanically zinc-coated steel sheets, each sheet having a thickness of 0.25 mm and dimensions of about 20 cm×30 cm were used. The two metal sheets were painted on one side with a conventional, commercially available, one-component primer (VP 13808, IGP GmbH, D-48249, Dülmen). The metal sheets were placed in a drying oven at 70° C. for approximately 15 minutes in order to ventilate and bake the primer. The PU reaction mixture was cooled to room temperature and then applied to the primed side of one of the metal sheets and, after the application, was immediately covered with the second metal sheet. The layer thickness of the PU material was adjusted to 1 mm and the laminate was stored for approximately 15 minutes at room temperature and then for approximately 30 minutes at about 70° C.

The peel resistance of the resulting laminate, measured in accordance with DIN EN 1464, was 21.3 N/cm. The workability by forming was examined by means of a bending test. To this end, the laminate was bent by 90° and then bent back again. No detachment of the resin from the metal was observed.

To establish the mechanical and thermomechanical data for the PU material used, test plates were produced in the laboratory. To this end, components A and B were weighed out in the ratio of 100:52 in a suitable vessel and mixed together for 15 seconds by means of a Pendraulik mixer at a stirring speed of 4200 rev/min. Then, 350 g of the mixture was placed in a flat mold (having dimensions of 200 mm×200 mm×10 mm) which was pre-heated to 70° C., the mold was closed and vented. Approximately 5 minutes after the mixture had been placed in the mold, it was possible to release the finished plate, the bulk density of which was approximately 875 kg/m³. After the plates had been stored for 24 hours at room temperature, the following mechanical and thermal properties were ascertained:

| | | |
|---|---|---|
| DIN 527-1 | Tear resistance at 20° C. [N/mm²] | 7.75 |
| DIN 527-1 | Elongation at tear at 20° C. [%] | 21.63 |
| DIN 527-1 | Tensile modulus at 20° C. [N/mm²] | 222 |
| DIN 53423 | Bending modulus at 20° C. [N/mm²] | 180 |
| DIN 53423 | Bending modulus at 80° C. [N/mm²] | 12.2 |

The decomposition temperature of the PU material was determined thermogravimetrically by means of TGA (Thermo Gravimetric Analysis). At a heating rate of 20 K/min, the onset of decomposition was observed at 277° C. and, at a heating rate of 5 K/min, at 253° C. FIG. 2 shows the graph obtained by DTA of the sample in nitrogen atmosphere at a heating rate of 5 K/min.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A laminated panel comprising
B1) a first layer of metal having a thickness of from 0.05 to 1.0 mm,
A) a layer of polyurethane resin having a thickness of from 0.05 to 10 mm, and
B2) a second layer of metal having a thickness of from 0.05 to 1.0 mm,
wherein said layer of polyurethane resin is located between said first layer of metal and said second layer of metal.

2. The laminated panel of claim 1, wherein said layer of polyurethane resin has a modulus of elasticity of <250 MPa.

3. A process for the production of a laminated panel having A) a layer of polyurethane resin between two layers of metal B1) and B2), said process comprising
(1) applying a reaction mixture between two layers of metal B1) and B2), wherein each layer of metal has a thickness of from 0.05 to 1.0 mm, and the reaction mixture comprises:
a) a polyisocyanate component,
b) a polyol component,
and, optionally, one or more of
c) components selected from the group consisting of cross-linking agents, chain extenders and mixtures thereof,
d) catalysts,
e) blowing agents,
f) compounds selected from the group consisting of fillers and reinforcing materials, and
g) auxiliary substances and additives, and
(2) curing the reaction mixture, thereby forming the laminated panel.

4. A process for the production of a laminated panel having A) a layer of polyurethane resin between two layers of metal B1) and B2), said process comprising:
(1) applying a reaction mixture to a first layer of metal B1) which has a thickness of from 0.05 to 1.0 mm, wherein the reaction mixture comprises:
a) a polyisocyanate component,
b) a polyol component,
and, optionally, one or more of
c) components selected from the group consisting of cross-linking agents, chain extenders and mixtures thereof,
d) catalysts,
e) blowing agents,
f) compounds selected from the group consisting of fillers and reinforcing materials, and
h) auxiliary substances and additives,
(2) placing a second layer of metal B2) over the reaction mixture, wherein the second layer of metal B2) has a thickness of from 0.05 to 1.0 mm, and
(3) curing the reaction mixture, thereby forming a laminated panel.

5. In a process for the production of a molded article comprising positioning a first layer of material over one inside portion of a mold and a second layer of material over the other inside portion of the mold, vacuum forming the layers of material into the mold, closing the mold, filling the mold with a reaction mixture, curing the reaction mixture, opening the mold, and removing the molded part, the improvement wherein the first layer of material comprises a metal having a thickness of from 0.05 to 1.0 mm, the second layer of material comprises a metal material having a thickness of from 0.05 to 1.0 mm, and the reaction mixture comprises a polyurethane resin forming reaction mixture.
